(19) United States
(12) Patent Application Publication
(10) Pub. No.: US 2026/0287129 A1
(43) Pub. Date: Sep. 24, 2026

(54) MODULAR STACKABLE LIGHT FIXTURE

(71) Applicant: 3form, LLC, Salt Lake City, UT (US)

(72) Inventors: Dax K. Pettibone, American Fork, UT (US); Ryan G. Smith, Seattle, WA (US); Guillaume Martin, Rochetoirin (FR); Justin-Elliot E. Vanier, West Valley City, UT (US); Bryce C. Anderson, Renton, WA (US)

(21) Appl. No.: 19/571,323

(22) Filed: Mar. 18, 2026

Related U.S. Application Data
(60) Provisional application No. 18/445,685, filed on Mar. 18, 2025.
(60) Provisional application No. 18/445,686, filed on Mar. 18, 2025.

(51) Int. Cl. F21S 2/00; F21S 8/06; F21V 1/08; F21V 1/14; F21V 17/06; F21Y 103/10; F21Y 115/10

(52) U.S. Cl. CPC F21S 2/005; F21S 8/063; F21V 1/08; F21V 1/143; F21V 17/06; F21Y 2103/10; F21Y 2115/10

(57) ABSTRACT

The modular stackable light fixtures of the present invention include collars, shades, and diffusers that allow users to construct or reconfigure cost-effective modular light fixtures. A modular light fixture can include a collar with one or more indexes and a receiving element within the neck of the shade. The neck features receiving elements that engage the indexes, and a retention mechanism locks the shade and collar in place. The shades can have various geometries and may include baffles, inner shells, and coupling elements.

### CROSS-REFERENCE TO RELATED APPLICATIONS

This application claims the benefit of and priority to U.S. Provisional Application No. 63/773,635 (Workman Nydegger Docket No. 15999.717), entitled MODULAR STACKABLE LIGHT DIFFUSERS, filed on Mar. 18, 2025, and U.S. Provisional Application No. 63/773,627 (Workman Nydegger Docket No. 15999.716), entitled MODULAR STACKABLE LIGHT FIXTURE, filed on Mar. 18, 2025. This application also incorporates the entirety of U.S. patent application Ser. No. ______ [Workman Nydegger Docket Number: 15999.717.1] for which the law firm of Workman Nydegger is authorized to update with the filing receipt of the same upon receipt), entitled “MODULAR STACKABLE LIGHT DIFFUSERS”, filed on Mar. 18, 2026, the entire content of which is incorporated by reference herein. [U.S. PROVISIONAL APPLICATION NOS. 63/773,635 (****ATTORNEY DOCKET 15999.717*****) AND 63/773,627 (***ATTORNEY DOCKET NUMBER 15999.716******) ARE THE SUBJECT OF CORRESPONDING PETITIONS TO CONVERT FROM PROVISIONAL TO UTILITY, NAMELY IN BOTH OF THE ABOVE PROVISIONAL APPLICATIONS ON MAR. 9, 2025. APPLICANTS AUTHORIZE THE LAW FIRM OF WORKMAN NYDEGGER TO UPDATE THE ABOVE TEXT TO REFLECT THE NON-PROVISIONAL APPLICATION NUMBERS WHEN KNOWN).

### BACKGROUND OF THE INVENTION

### 1. Technical Field

The present invention pertains to modular, stackable lighting systems.

### 2. Background and Relevant Art

Conventional lighting systems often feature static designs that limit customization and adaptability. These systems may include fixed lamp shades that do not allow for easy replacement or modification, which can be problematic for users seeking to update their decor or repair damaged components. Additionally, traditional lamp shades and lighting systems may rely on mechanical fasteners or adhesives that can be cumbersome to assemble and disassemble, potentially leading to wear and tear over time.

Furthermore, conventional lighting systems typically lack modularity, meaning users cannot easily change the appearance or functionality of their lamps. This rigidity can be a significant drawback for those who desire a more dynamic, personalized lighting solution. The materials used in traditional lamp shades may also be limited in variety, restricting the range of aesthetic and functional effects that can be achieved.

Overall, these limitations highlight the need for more innovative lighting solutions that offer greater flexibility, ease of assembly, and customization options.

Accordingly, there are a number of difficulties in the art of light fixtures that can be addressed.

### BRIEF SUMMARY OF THE INVENTION

Implementations of the present invention comprise systems, methods, and apparatus related to modular light fixtures. In particular, implementations of the present invention can comprise collars, shades, and diffusers that allow a user or assembler to construct or reconfigure cost-effective modular light fixtures that align with aesthetic and functional design goals.

A modular light fixture can comprise a collar having one or more indexes that protrude outward and radially, a shade having a neck defining an opening to receive the collar, a diffuser disposed within an internal volume of the shade, and a retention mechanism that resists rotation of the collar relative to the shade. The neck can comprise one or more receiving elements that engage the one or more indexes upon relative rotational movement between the collar and the shade. The collar and the neck can form a friction fit after rotational engagement that resists axial separation. The collar can also comprise a coupling mechanism that can engage the diffuser and retain the diffuser within the internal volume of the shade.

A shade for use in modular light fixtures can include one or more external baffles that extend from a first end of the shade to a second end of the shade. Each of the one or more external baffles can comprise an interior edge and an outer edge. The shade can also include an inner shell that engages the interior edge of the one or more external baffles. The shade can also include a neck disposed at the first end of the shade. The neck can define an opening into an internal volume of the shade. The neck can also comprise one or more receiving elements that recess into the inner shell. The outer edge of the one or more external baffles can form an outermost perimeter of the shade.

A collar for use in modular light fixtures can include a body having an upper surface and a lower surface. The collar may also include one or more walls that extend from the lower surface of the body and define a central opening. The collar may also include one or more apertures that extend through the body between the upper surface and the lower surface, and one or more indexes that extend radially from the one or more walls. The collar may also include a central support structure disposed within the central opening.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a modular light fixture of the present disclosure;

FIG. 1B illustrates a cluster of modular light fixtures of the present disclosure;

FIG. 2A illustrates a cylindrical totem shade of the present disclosure;

FIG. 2B illustrates a cross-sectional view of the cylindrical totem shade of FIG. 2A;

FIG. 3A illustrates a perspective view of a saucer pendant shade of the present disclosure;

FIG. 3B illustrates a cross-sectional view of the saucer pendant shade of FIG. 3A;

FIG. 4A illustrates a top-perspective view of a collar of the present disclosure;

FIG. 4B illustrates a bottom perspective view of the collar of FIG. 4A;

FIG. 4C illustrates a bottom plan view of the collar of FIG. 4A;

FIG. 4D illustrates a side cross-sectional view of the collar of FIG. 4A;

FIG. 5A illustrates a top-perspective view of a collar of the present disclosure;

FIG. 5B illustrates a bottom perspective view of the collar of FIG. 5A;

FIG. 5C illustrates another bottom perspective view of the collar of FIG. 5A;

FIG. 5D illustrates a side plan view of FIG. 5C;

FIG. 5E illustrates a different side cross-sectional view of the collar of FIG. 5A;

FIG. 6A illustrates a totem light fixture of the present disclosure;

FIG. 6B illustrates another embodiment of a totem light fixture of the present disclosure;

FIG. 7A illustrates a horizontal totem light fixture of the present disclosure;

FIG. 7B illustrates a cross-sectional view of an end of the horizontal totem light fixture shown in FIG. 7A;

FIG. 7C illustrates a cross-sectional view of an intermediate member of the horizontal totem light fixture shown in FIG. 7A;

FIG. 7D illustrates a cross-sectional view of another end of the horizontal totem light fixture shown in FIG. 7A;

FIG. 8A illustrates a mounted totem light fixture of the present disclosure;

FIG. 8B-1 illustrates a cross-sectional view of the base of the mounted totem light fixture shown in FIG. 8A;

FIG. 8B-2 illustrates a perspective and partially exploded view of the base of the mounted totem light fixture shown in FIG. 8A;

FIG. 9A illustrates a nested light fixture of the present disclosure;

FIG. 9B illustrates another embodiment of a nested light fixture of the present disclosure;

FIG. 10A illustrates a diffuser of the present disclosure;

FIG. 10B illustrates another embodiment of a diffuser of the present disclosure;

FIG. 10C illustrates yet another embodiment of a diffuser of the present disclosure; and

FIG. 11 illustrates a sequence of inserting a film into a diffuser of the present disclosure.

### DETAILED DESCRIPTION OF THE PREFERRED EMBODIMENTS

The present invention extends to systems, methods, and apparatus related to modular light fixtures. In particular, implementations of the present invention can comprise collars, shades, and diffusers that allow a user or assembler to construct or reconfigure cost-effective modular light fixtures that align with aesthetic and functional design goals.

Accordingly, the present disclosure relates to modular light fixtures for use in public and private spaces. Specifically, the present disclosure provides modular light fixtures with removable shades and collars configured for modular locking and assembly. Users of modular light fixtures of the present disclosure will appreciate the configurability and customizability of the modular light fixtures, as they allow a user or assembler to assemble or reconfigure the modular light fixture cheaply. For example, the collars of the present disclosure allow support for one or more shades that a manufacturer can construct in various shapes, patterns, or designs, which users can select to suit a specific design aesthetic or functional purpose.

Users can assemble or reconfigure modular light fixtures of the present disclosure using a retention member to couple a collar to a shade (e.g., a set screw, a magnet, etc.). A user can insert a collar into the neck of a shade and twist it relative to the shade to engage elements of the collar with elements of a shade's neck. This twisting engagement process alone allows a collar to support and secure a shade. Magnets embedded within the collar and the neck of the shade can advantageously provide a retention force that can resist the collar and shade from disengaging from one another.

Manufacturers of modular light fixtures of the present disclosure can construct shades, collars, and diffusers from Polylactic Acid (PLA), Polyethylene Terephthalate Glycol (PETG), Acrylonitrile Butadiene Styrene (ABS), Polycarbonate (PC), Thermoplastic Polyurethane (TPU), Polyvinyl Alcohol (PVA), Polyethylene (PE), or a similar material. Manufacturers may also construct shades, collars, and diffusers from metals, alloys, woods, composites, rubbers, etc. A manufacturer can choose the material based on the specific aesthetic or function design goal they have in mind for the modular light fixture. For example, PLA can be used in a 3D printer to produce components with a smooth finish that provides a sleek and clean aesthetic. Alternatively, PETG can be selected for its durability and flexibility characteristics.

Furthermore, the manufacturer can choose a colored material or utilize colored inserts within the diffuser to change the perceived color of the light output by the modular light fixtures.

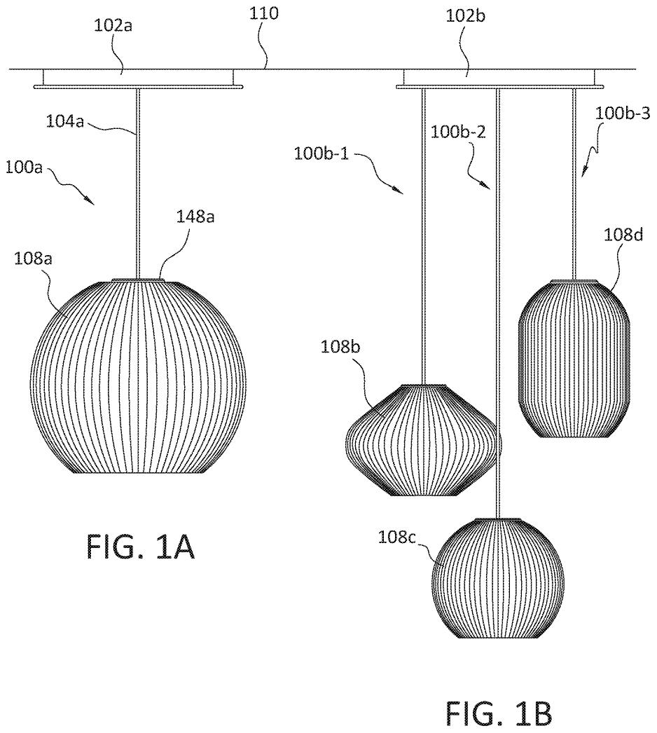

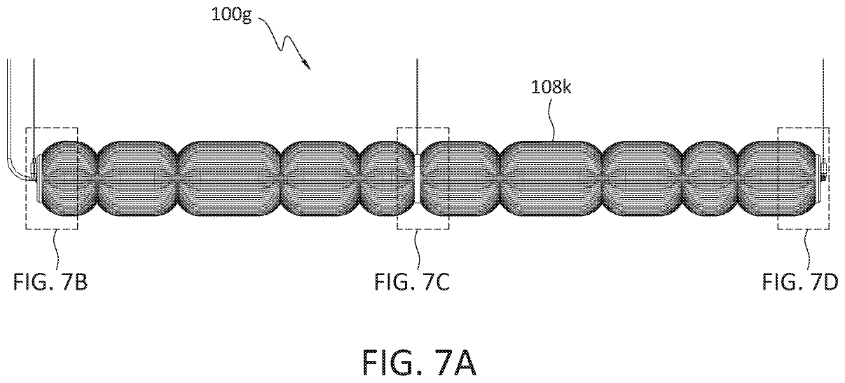

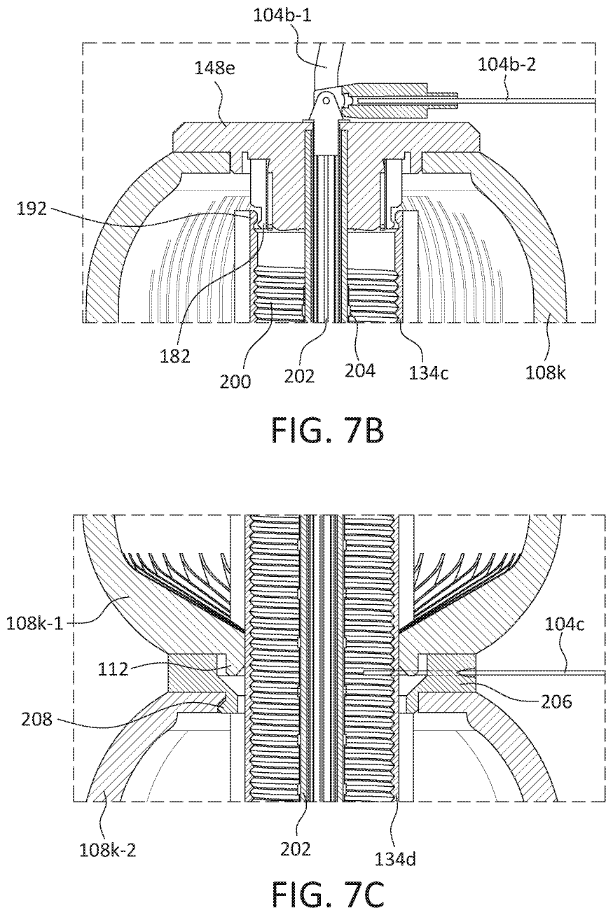

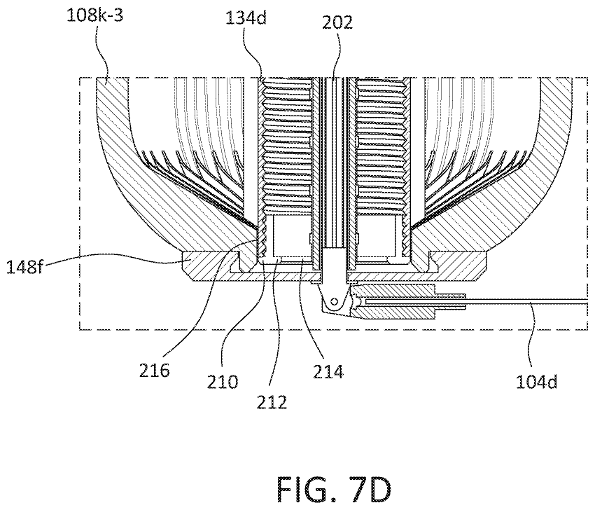

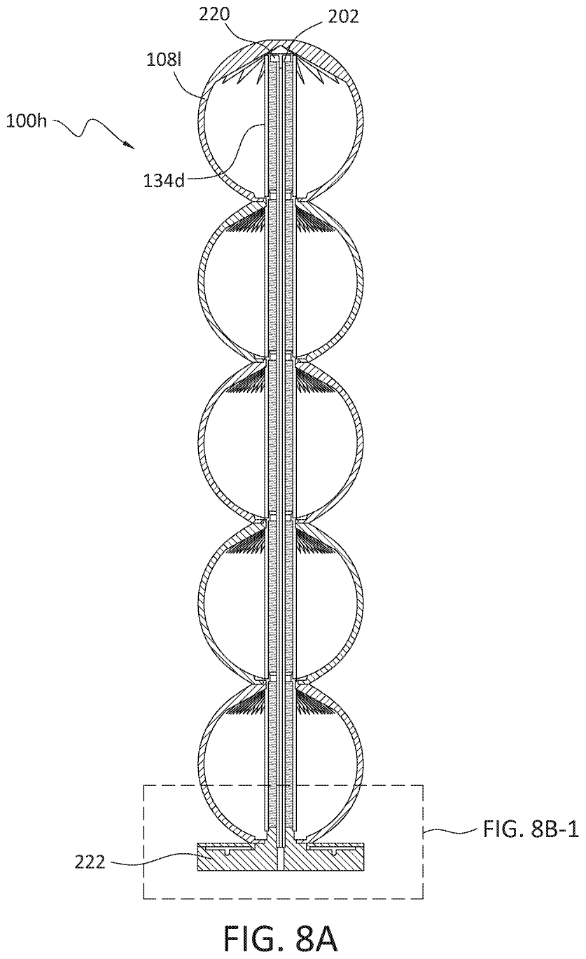

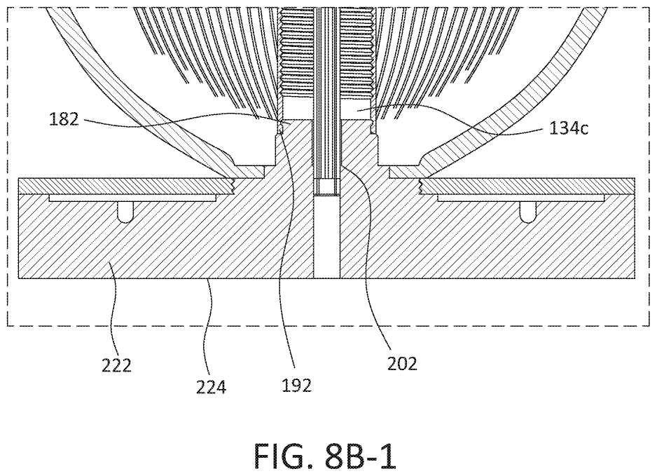

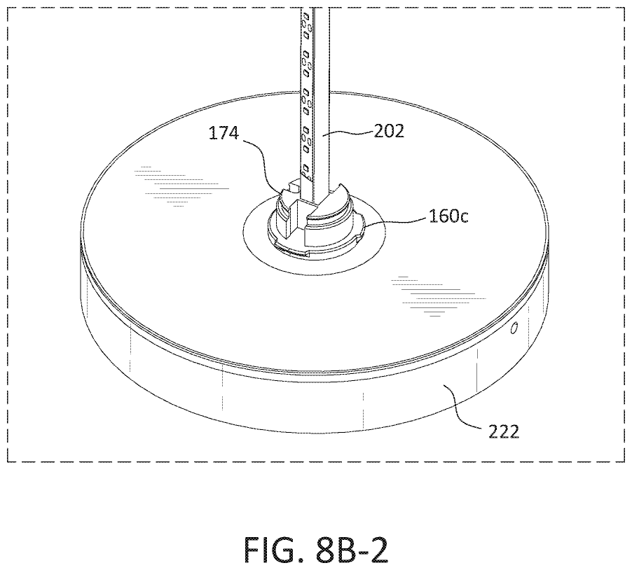

The present disclosure teaches vertical hanging light fixtures (see FIG. 1A), horizontal hanging light fixtures (see FIG. 7A), and free-standing or mounted light fixtures (see FIG. 8A). Thus, the modular light fixtures of the present disclosure can be configured to reside on tables, floors, and walls. Additionally, the modularity of the modular light fixtures allows a user to easily disassemble and reassemble the light fixtures for regular cleanings without having to undergo a complex disassembly process.

Turning now to the Figures, FIG. 1A illustrates a modular light fixture 100a. Light fixture 100a can include base 102a, support 104a, collar 148a, and shade 108a. Base 102a can secure to a ceiling or similar support surface 110 and act as an anchor point from which an assembler can secure or hang shade 108a. Base 102a can have a power supply or requisite wiring harness(es) to allow for the passage of power from a power source into a light source within shade 108a. Base 102a may sit flush with the support surface 110 or extend outwards and away from the support surface 110. Should base 102a not sit flush with support surface 110, base 102a can extend into a cavity or space defined at least partially by support surface 110.

FIG. 1A shows that support 104a can couple base 102a with a collar 148a. Support 104a can be a rigid or semi-rigid hollow tube, cable, or similar member with sufficient strength to support the weight of one or more shades 108 and any added lighting hardware or supports. Support 104a can secure base 102a and collar 148a together through one or more fasteners, threaded elements, indexed elements, or similar securing means. In at least one embodiment, support 104a can include one or more swivel elements or can couple to one or more swivel elements disposed on base 102a or collar 148a. The swivel elements can allow mounting base 102a on a non-level support surface or allow positional adjustment of shade 108a relative to base 102a. A user will appreciate the adjustability and versatility of support 104a, as a user can utilize support 104a to install light fixture 100a into an existing space without commissioning a bespoke light fixture. Additionally, support 104a can include telescoping or extending portions along its length to allow for the expansion or contraction of its overall length. Similarly, one or more supports 104a can selectively couple to one another to vary the overall length.

FIG. 1A shows collar 148a selectively coupled to shade 108a. The figure shows that collar 148a is positioned at or within the neck region of shade 108a. As described in more detail later in the description, complementary engagement structures, such as protruding indexes and receiving elements, can provide a twist-to-lock engagement between the collar 148a and the shade 108a. As used herein, “index” refers to a protrusion, lug, fin, rib, cam surface, projection, or similar structure configured to engage a complementary receiving element. As used herein, a “receiving element” refers to any recess, slot, channel, groove, cavity, ramped surface, pocket, indentation, cutout, bayonet feature, cam surface, or other complementary structure configured to receive, engage, cooperate with, or interface with a protruding structure such as an index. This twist-to-lock engagement can cause a frictional fit between the parts sufficient to retain the parts together. For example, the indexes and the receiving elements can include sloped or tapered surfaces that increase frictional engagement as the components are rotated relative to one another. However, an additional retention member (such as a set screw or magnets) may further resist the un-twisting of the two parts.

FIG. 1A shows that shade 108a has a substantially spherical geometry. As shown throughout the disclosure, shades 108 can have various geometries. For example, shade 108 may have a square, rectangular, triangular, conical, sloped, curved, etc. outer cross-section. Furthermore, shade 108a is shown having a flat bottom that may define an opening to allow for the passage of light. As shown herein, shades 108 of the present disclosure may take the form of a totem, a pendant, or an open-bottom shade. As used herein, “totem” means the shade can selectively couple to one or more other shades, “pendant” means the shade can have a closed lower region, and “open-bottom” means the shade can have an opening in its lower region (such as shade 108a). Various Figures illustrate these various shade forms and features.

FIG. 1B illustrates a light fixture or light fixture cluster which is defined by modular light fixtures 100b-1, 100b-2, and 100b-3. Base 102b can support each sub-light fixture 100b-1, 100b-2, and 100b-3. Base 102b can have one or more apertures or connection elements to secure one or more light fixtures 100b-1, 100b-2, and 100b-3. The illustrated light fixture cluster includes shades 108b, 108c, and 108d at heights or distances relative to base 102b. In another embodiment, an assembler can install shades 108b, 108c, and 108d at the same height or distance from base 102b. For example, a user may want a linear row of lights and can install shades 108b, 108c, and 108d such that they are side by side in a row.

The configuration shown in FIG. 1B demonstrates that the modular light fixtures of the present disclosure may be selectively arranged to achieve different visual and functional lighting effects without redesigning the underlying components. By permitting independent positioning of each modular light fixture relative to base 102b, the system provides flexibility in light distribution, aesthetic presentation, and spatial coverage. An installer may tailor the cluster to a particular environment, ceiling height, or design preference while utilizing standardized components. This modularity can simplify manufacturing and inventory management, reduce installation complexity, and allow subsequent reconfiguration of the light fixture cluster after initial installation.

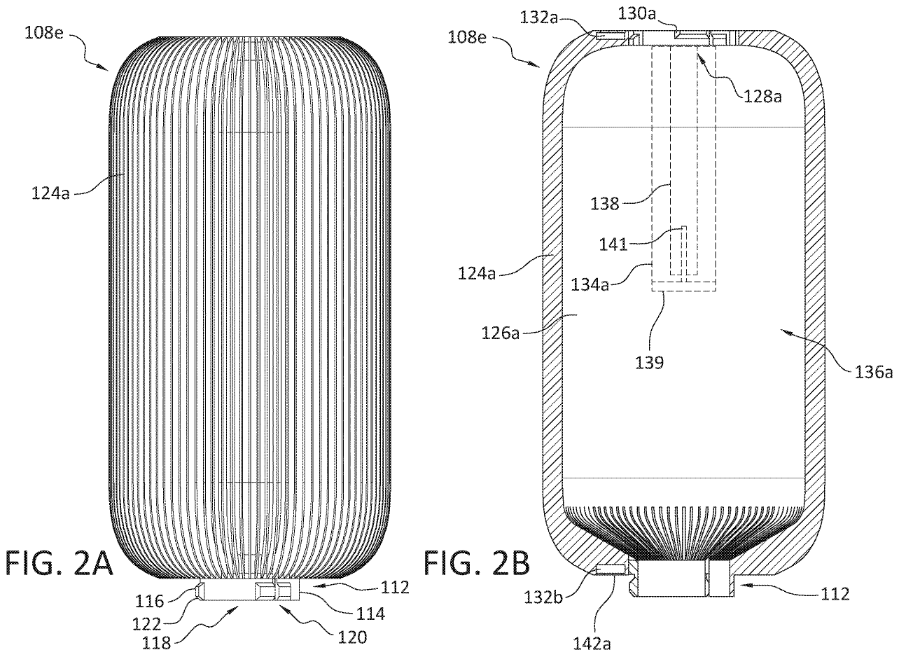

FIG. 2A illustrates shade 108e, a totem shade with a cylindrical cross-section. As previously discussed, shade 108a can couple to one or more additional shades by way of connection element 112. As shown, connection element 112 is positioned at or near an end (e.g., the top or bottom) of shade 108a, thus allowing for the end-to-end stacking of one or more totem shades. Connection element 112 can include one or more walls 114 and one or more indexes 116 that protrude radially and outwardly from one or more walls 114. For example, totem shade 108e can have three walls 114 that define an opening 118. Opening 118 can be circular. Opening 118 can provide for the passage of wiring, lights, or other components of a modular light fixture through one shade and into another. A manufacturer can include a slot 120 or space between each of the walls 114 to provide the indexing or coupling to corresponding features of another shade or collar of the present disclosure. For example, slot 120 can receive a fin or indexing member of a diffuser, shade, or collar. This can allow for slot 120 to assist in preventing the un-twisting of one shade to another. Walls 114 can extend outward and away from shade 108e, providing a surface on which a manufacturer can install one or more indexes 116.

FIG. 2A shows that index 116 can be a protrusion from the surface of wall 114. Index 116 can allow an assembler to secure one shade to another after a twisting motion of the collar and shade, or to secure two individual shades. Index 116 can interrelate with the corresponding elements or recesses on another shade (illustrated in FIG. 2B). Index 116 can have one or more chamfered or angled sides 122 or an overall tapered shape. These angled sides, 122, or overall tapered shape, allow an assembler to easily lock one shade to another by twisting the totems about their vertical axis, aiding the alignment of index 116 with the corresponding elements of the other shade. The overall shaping of each index 116 can also cause the frictional engagement between a shade and a collar or between two shades. For example, during a twisting motion of a collar relative to a shade, the shaping of the index 116 can cause the index to slide along a cam surface of an element or recess, such that friction makes untwisting difficult or more unlikely without an intervening force.

FIG. 2A also shows that shade 108e has an overall cylindrical shape with rounded ends (such as at or near a neck area and at or near the connection element). Furthermore, shade 108e is shown having one or more baffles 124a that extend between the ends. A manufacturer can dispose of the baffles 124a on the outer surface of the totem shade 108e such that they protrude from the body or inner shell of the shade. Baffles 124a can have a length equivalent to the overall length of totem shade 108e and can define the visual shape of totem shade 108e. For example, the baffles 124a can extend for the entire length of the shade 108e. Baffles 124a can protrude or extend from an inner shell 126a (shown in FIG. 2B). Baffles 124a can have a thickness, and a manufacturer can space baffles 124a apart at a set interval or random interval around the outer surface of the inner shell 126a.

In addition to defining the external appearance of shade 108e, baffles 124a can provide structural reinforcement to the shade body. For example, where shade 108e is formed by an additive manufacturing process such as three-dimensional printing, the baffles 124a can function as ribs that increase rigidity and resistance to deformation without substantially increasing material usage. The protruding geometry of baffles 124a can increase section modulus and improve resistance to bending, denting, or torsional loads that may occur during handling, installation, or use. In this manner, the baffles 124a can permit the shade 108e to be formed with relatively thin wall sections (such as the inner shell) while maintaining desired strength and durability characteristics.

Further, baffles 124a can influence the optical performance of the modular light fixture. Because baffles 124a protrude from inner shell 126a and define surface contours along the exterior of shade 108e, they can affect the manner in which light emitted from an internal light source passes through or around the shade. Depending on material selection, thickness, spacing, and geometry, baffles 124a can diffuse, channel, or partially occlude light, thereby modifying perceived brightness, warmth, glow, and shadow patterns. As a result, baffles 124a can serve both structural and optical functions, allowing a designer to tailor mechanical performance and lighting aesthetics through a common set of features.

FIG. 2B illustrates a cross-sectional view of the cylindrical totem shade 108e of FIG. 2A. Inner shell 126a can be multipart or monolithic in construction. For example, a manufacturer can extrude or additively print (i.e., 3D print) shades of the present disclosure. In such a case, a manufacturer can advantageously construct a multipart inner shell 126a and not have to use a large or oversized printer or extruder. Baffles 124a can be independent elements so that they clip together or to the inner shell 126a. In another embodiment, a manufacturer adheres baffles 124a to the inner shell 126a. In at least one embodiment, shade 108e is monolithic in construction, and the manufacturer extrudes, prints, or constructs shade 108e as a single piece.

FIG. 2B illustrates that shade 108e has neck 128a at one end and a coupling element at the opposing end. Neck 128a can define an opening configured for receiving a collar of the present disclosure or a coupling element 112 of another totem shade. The opening can act as a passage into an internal volume defined by the inner shell 126a. As shown, neck 128a can have receiving elements 130a disposed around the circumference of its opening, which are corresponding features that interrelate with index 116 (shown in FIG. 2A). For example, in at least one embodiment, the receiving elements 130a can be tapered or chamfered, similar to index 116. The tapering or chamfering can allow an assembler to easily twist one or more shades together or a shade and a collar such that the receiving element 130a and the index 116 frictionally lock together.

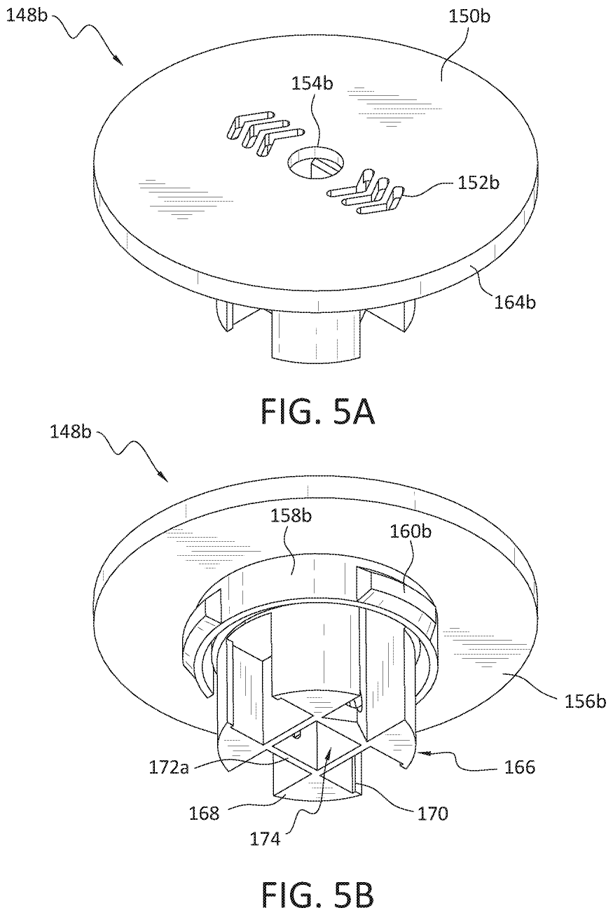

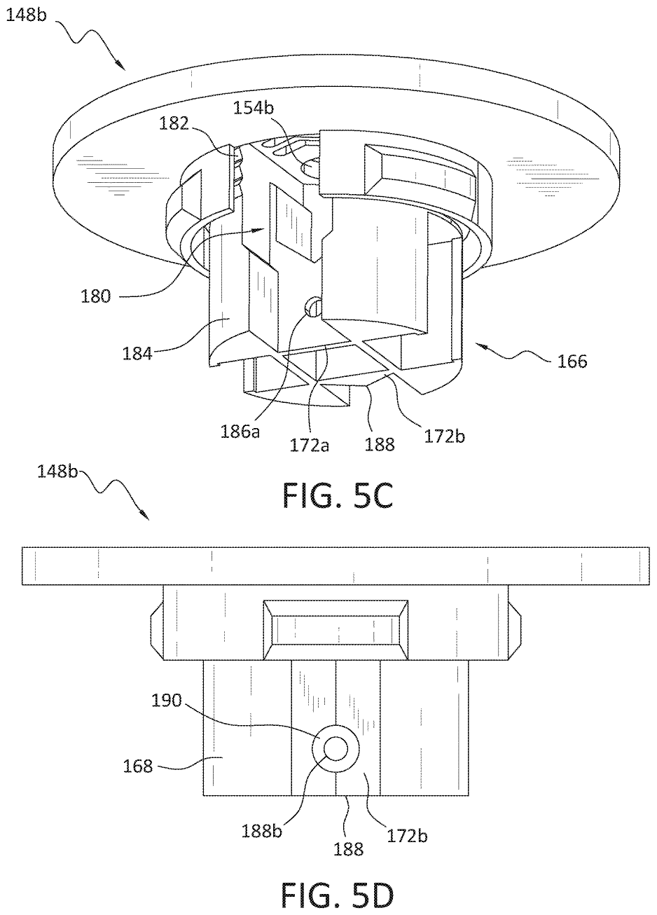

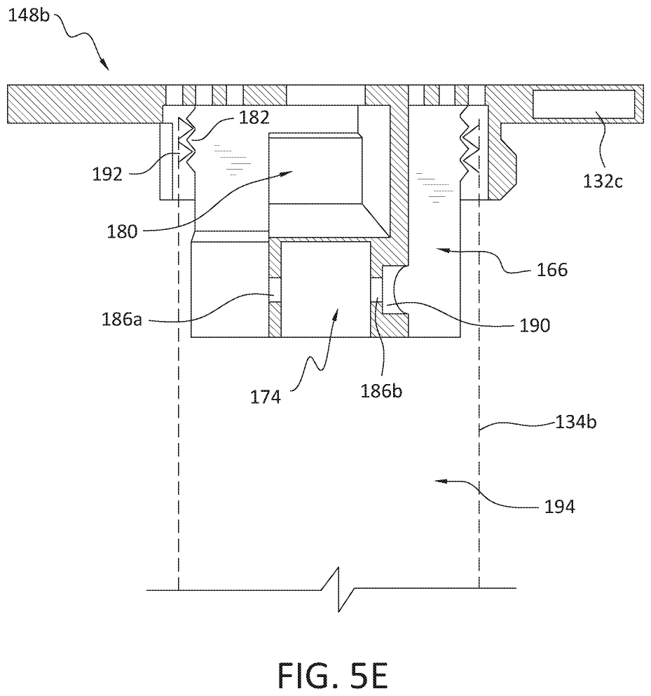

FIG. 2B shows that neck 128a can include one or more compartments 132a. In at least one embodiment, compartment 132a can be an aperture or threaded hole configured to receive a set screw. A manufacturer can include one or more compartments 132a around the circumference of the neck 128a at predefined or random intervals. Compartment 132a can receive a magnet or set screws configured to assist in locking a collar of the present disclosure or a coupling element of another shade in place once an assembler twists them together. For example, a manufacturer can install the magnets equally spaced around the opening defined by neck 128a in compartment(s) 132a. Accordingly, collars of the present disclosure can be inherently magnetic or include one or more magnetic elements that can couple to the magnets in compartments 132a. (See compartment 132c in FIG. 5E). Similarly, coupling element 112 can be inherently magnetic or can include one or more magnetic elements embedded within or on its surfaces. For example, a compartment 132b near the coupling element 112 may retain a magnet. Shade 108e may further include a bottom surface 142a that can be substantially flat or level to align with the upper surface of a different totem shade.

FIG. 2B illustrates that a diffuser 134a can reside within an internal cavity 136a defined by an inner shell 126a. Diffuser 134a can couple to a collar of the present disclosure or directly to neck 128a. For example, an assembler can twist and lock the diffuser 134a into the neck 128a, similar to how a collar or coupling element is secured. Diffuser 134a can include a lighting support structure 138, wiring, and a lighting element. The light element and lighting support structure 138 can extend the length of the diffuser 134a or only a portion of its length. Similarly, a manufacturer can install a lighting support structure 138 centered within diffuser 134a or at a specific position within diffuser 134a.

Lighting support structure 138 can be a linear extrusion or member that acts as a support for any type of light, such as LED, incandescent, halogen, compact fluorescent, or similar. For example, the lighting support structure 138 can be a hollow metal extrusion that supports one or more strips of LEDs. The lighting support structure 138 can thus anchor at the collar and at a cap 139 that is positioned at an end of the diffuser. For example, in at least one embodiment, a pin 141 that extends from the cap 139 can extend into a hollow lumen of the lighting support structure 138. In another embodiment, the cap 139 can include an aperture or recess that allows for the lighting support structure to engage with. These two points of contact can allow the lighting support structure 138 to remain centered within the diffuser 134a (thus allowing for consistent lighting effects along the entire length of the diffuser 134a).

In at least one embodiment, the diffuser 134a can allow a power source to connect to or disconnect from the light element or light source inside quickly. For example, pins or pads can be present on the outer surface of the diffuser 134a to allow for a contact-based connection with wiring connected to a power source. Furthermore, the diffuser 134a can be transparent or semi-transparent to allow light from light element or light source to pass through it and reach a viewer outside of shade 108e. Diffuser 134a may also be textured or colored to further influence the light that reaches a viewer outside of the shade 108e.

In at least one embodiment, diffuser 134a can be configured to couple directly to another diffuser of the present disclosure to form an extended lighting assembly or diffuser bar (see FIG. 8A). For example, diffuser 134a can include internal threading formed along at least a portion of its inner surface. In some embodiments, the internal threading extends for more than one-half of the axial length of diffuser 134a, and in other embodiments for more than two-thirds of the axial length. By extending the threaded region along a substantial portion of the diffuser body, diffuser 134a can be cut or shortened to a selected length while still retaining sufficient threaded engagement to couple with another diffuser or cap. This configuration permits a lighting support structure or diffuser bar to be sized to correspond to the combined length of multiple shades coupled together, thereby facilitating custom overall fixture heights while maintaining secure mechanical and axial alignment between connected components.

In at least one embodiment, the threading can be continuous or segmented and can be integrally formed during extrusion or additive manufacturing of the diffuser body. The extended threaded engagement can distribute mechanical loads over a greater surface area, which may be beneficial in longer stacked configurations where multiple diffusers are coupled end to end. Additionally, diffuser 134a can include alignment features such as fins that extend radially outward from its outer surface that cooperate with slots 120 of a shade to prevent relative rotation once fully seated. For example, 1, 2, 3, 4, or more fins can protrude from the outer surface of the diffuser.

By permitting diffuser-to-diffuser coupling, the modular light fixture can be extended in length without requiring replacement of the entire light fixture assembly. This arrangement supports the scalability of light output, simplifies customization of fixture height, and allows selective replacement or servicing of individual diffuser segments while maintaining a consistent external appearance and lighting performance.

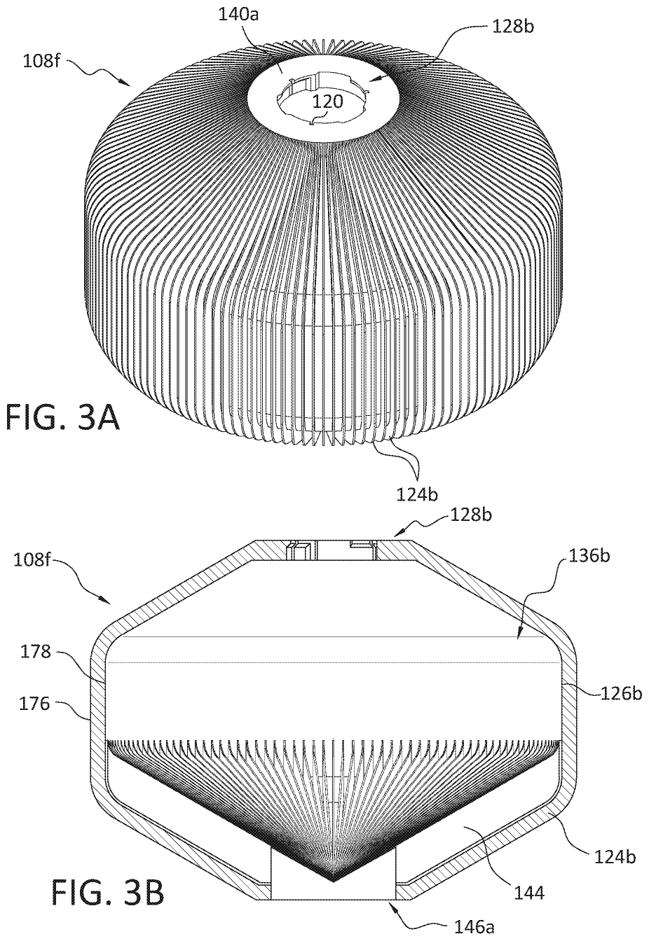

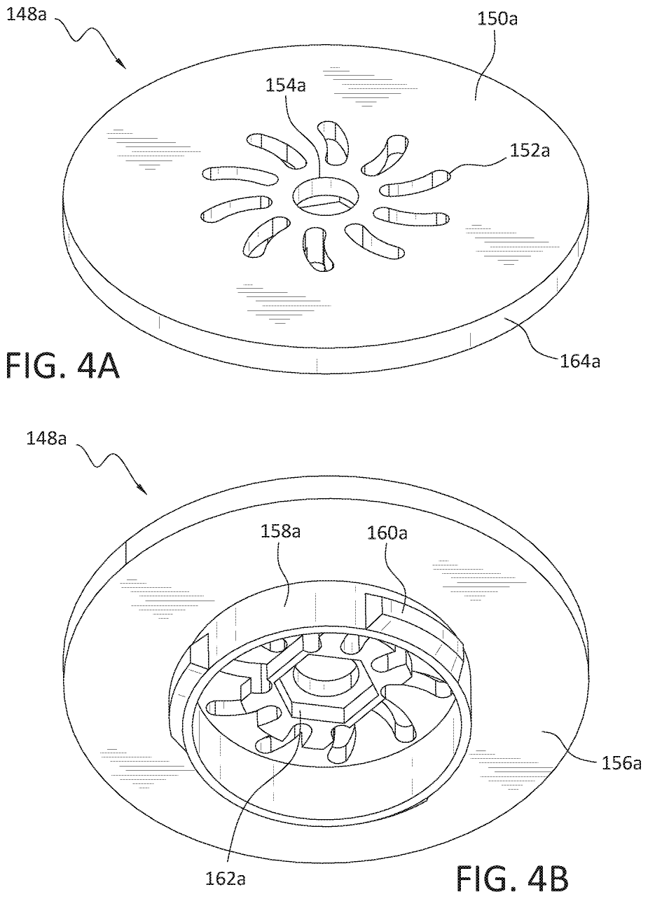

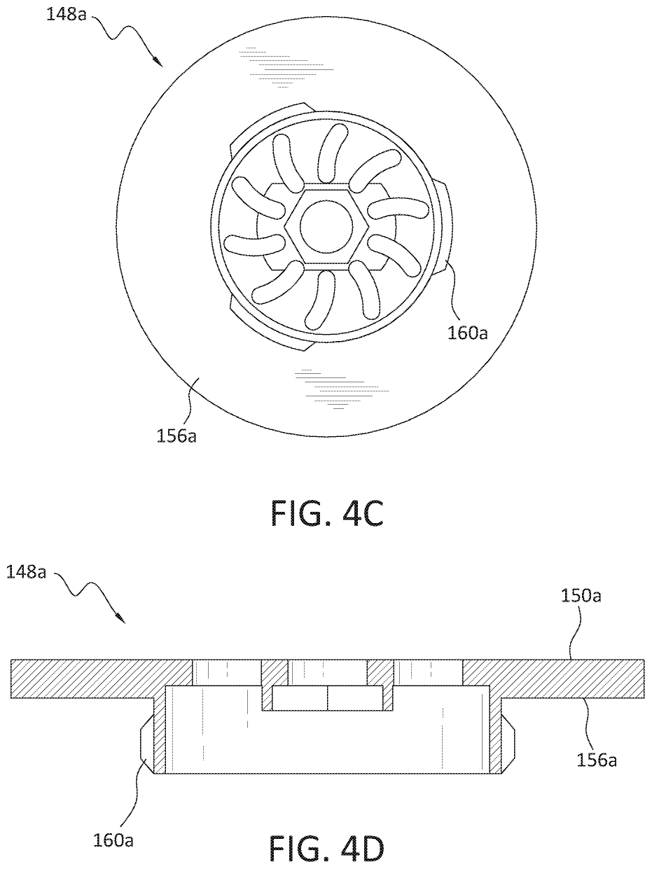

FIG. 3A illustrates a perspective view of shade 108f, which is a saucer-shaped pendant shade. As previously discussed, a pendant shade can be a closed bottom shade, thus unable to couple with multiple additional shades. Shade 108f can include one or more baffles 124b and a neck 128b. Neck 128b can include an upper surface 140a configured for abutting a bottom surface 142a or 156a (shown in FIG. 2B or 4B) or engaging with a collar, stand or mount. As previously mentioned, a manufacturer can embed one or more magnets within the neck 128b or provide apertures or threaded holes to allow for the insertion of a retention mechanism such as a set screw. The retention mechanism may comprise magnetic elements, threaded engagement, frictional cam surfaces, set screws, diffuser fins engaging slots, or combinations thereof.

The substantially flat nature of the upper surface 140a can allow one or more magnets to better interface with a magnetic collar or magnets disposed in the bottom surface 142a of a shade (seen in FIG. 2B). A manufacturer will appreciate that in at least one embodiment, the magnets embedded in the upper surface 140a and bottom surface 142a (seen in FIG. 2B) are positioned such that they interface together when the two shades are twisted and locked into place. The magnets can then provide a retention force to resist the shades from un-twisting or unlocking.

Additionally, the substantially flat nature of surface 140a can promote proper axial alignment between coupled components, helping to maintain a straight and visually continuous stack when multiple shades, collars, or mounting elements are assembled together.

FIG. 3B illustrates a cross-sectional view of the shade 108f of FIG. 3A. As illustrated, shade 108f can include one or more internal baffles 144 in addition to external baffles 124b. In at least one embodiment, internal baffles 144 correspond positionally with external baffles 124b such that the two form aligned rib structures extending between an outer surface and an inner region of the shade. Aligning internal baffles 144 with external baffles 124b can be beneficial from an optical standpoint, as the overlapping rib structures can consolidate areas of light interruption into common regions rather than creating offset obstructions that produce irregular shadowing. By maintaining positional correspondence, the baffles can reduce unintended shadow patterns, banding, or nonuniform light artifacts, thereby promoting a more consistent glow and controlled light distribution from the internal cavity 136b.

The dimensional relationship between external baffles 124b and internal baffles 144 can vary. For example, the radial projection or thickness of the internal baffles 144 relative to the external baffles 124b can be approximately 1:1, 1:2, 1:3, 1:4, 1:5, 1:6, 1:7, 1:8, 1:9, 1:10. Similarly, spacing between adjacent internal baffles 144 can correspond directly to spacing between adjacent external baffles 124b, or may be more closely spaced to increase structural reinforcement without substantially altering the external aesthetic.

The inclusion of internal baffles 144 can increase compressive strength, torsional rigidity, and resistance to deformation of a shade 108, particularly where the shade 108 is formed from polymeric materials using extrusion or additive manufacturing processes. The rib-like configuration can increase section modulus and distribute loads more evenly throughout the shade body, thereby permitting thinner wall sections while maintaining structural integrity.

In at least one embodiment, internal baffles 144 may be disposed only along a portion of the axial length of shade 108f, such as near neck 128b or near a closed bottom portion of the pendant shade. The internal baffles may then extend less than half way or less than a quarter of the length of the length of the shade. This selective placement can reinforce areas subject to higher stress during installation or coupling while reducing material usage elsewhere. In additive manufacturing embodiments, internal baffles 144 positioned near one end of the shade can improve print stability, reduce warping, and enhance layer adhesion during fabrication. Accordingly, internal baffles 144 can be continuous along the full length of shade 108f, segmented, or localized to one or more regions depending on structural and manufacturing requirements.

FIG. 3B shows baffles 124b having an outer edge 176 and an interior edge 178. The outer edges 176 of baffles 124b can define an outermost perimeter of shade 108f. Interior edge 178 can abut the inner cavity 136b or inner shell 126b. Though shown being substantially linear, the baffles may also include waves, curves, bends, etc.

In another embodiment, a shade may not have any baffles. Rather, the shade may have a textured or complex geometry such as waves, folds, creases, ridges, bumps, etc. In such an embodiment, the shade may have only a singular layer of material that defines the outer and inner surfaces. Alternatively, multiple layers of material can define the outer and inner surfaces of the shade. In such an embodiment, internal baffles may or may not be present. For example, a manufacturer may use a single layer of material with ridges and valleys (or folded creases) that provide a visual aesthetic similar to the aesthetic provided by the baffles disclosed herein.

As shown in FIG. 3B, inner shell 126b can extend to define the entire internal cavity and divide internal baffles 144 from baffles 124b. Shade 108f can have a bottom portion 146a that is closed. In one embodiment, the bottom portion 146a can be transparent or semi-transparent, while in another embodiment, the bottom portion 146a can stop all transmission of light. Similarly, inner shell 126b, baffles 124b, and internal baffles 144 can be transparent or semi-transparent or configured to stop all transmission of light. A manufacturer can vary which components allow light transmission to accomplish various functional and aesthetic outcomes.

FIG. 4A illustrates a top-perspective view of collar 148a. Collar 148a can include an upper surface 150a, apertures 152a, and aperture 154a. Upper surface 150a can be substantially circular. In another embodiment, upper surface 150a can take a different geometric shape, such as a square or triangle. Upper surface 150a can define one or more apertures 152a and 154a. Apertures 152a can allow for the passage of warm air that may build up inside a shade to which the collar 148a is secured. Additionally, aperture 152a can provide an engagement point for an assembler to insert a leveraging tool to tighten or loosen the collar on a shade. Aperture 154a can selectively couple to supports of the present disclosure (see FIG. 1A) and allow passage of wires or cables from outside a shade into the shade. Additionally, a diffuser or light element may selectively couple with apertures 152a and/or 154a using one or more fasteners. For example, an assembler may secure a light element configured for throwing light directionally (i.e., downwards toward the ground) to collar 148a (or any other collar of the present disclosure).

A manufacturer can construct collar 148a from a similar material to the shades of the present disclosure. In at least one embodiment, collar 148a can be constructed from a material with magnetic properties. A manufacturer can also embed one or more magnets into body 164a so that collar 148a and a shade of the present disclosure can magnetically interface and resist de-coupling. A manufacturer may also size and position one of the shown apertures (or include an additional aperture) to allow for the use of a set screw.

FIG. 4B illustrates a bottom perspective view of collar 148. Collar 148a can further comprise wall 158a (analogous to wall 114) and indexes 160a (analogous to index 116). Together, wall 158a and indexes 160a form an element analogous to connection element 112, allowing an assembler to couple collar 148a to the neck of a shade. Collar 148a can also include recess 162a, enabling the coupling or securing of a diffuser or light element.

In at least one embodiment, wall 158a extends axially and protrudes away from the bottom surface 156a of collar 148a such that it forms a cylindrical or partially cylindrical skirt configured to be received within a corresponding neck of a shade. Wall 158a can define an outer engagement surface sized for a friction fit with an inner surface of the neck. Indexes 160a can protrude radially outward from wall 158a and can be circumferentially spaced around wall 158a at predefined intervals. In some embodiments, indexes 160a include tapered, chamfered, or ramped surfaces that facilitate insertion and rotational engagement with corresponding receiving elements formed in the neck of a shade. The tapered surfaces can guide the indexes into position during twisting movement and can create a wedging action that increases frictional retention once fully seated. The geometry, height, and circumferential length of indexes 160a can be selected to balance ease of assembly with resistance to unintended rotation or axial disengagement.

As shown, recess 162a can be centrally disposed within collar 148a and can be dimensioned to receive an end portion of a diffuser, lighting support structure, or electrical connector. Recess 162a can include internal threading, one or more detents, a friction fit surface, or a keyed geometry configured to align and retain the diffuser relative to collar 148a. In some configurations, recess 162a can also provide a pathway for electrical conductors to pass through collar 148a toward a power source or adjacent modular light fixture. By integrating recess 162a into collar 148a, the collar can serve both as a mechanical coupling interface with the shade and as a structural and alignment interface for internal lighting components and a diffuser, thereby simplifying assembly and promoting consistent axial alignment of the diffuser within the shade.

FIG. 4C illustrates a bottom plan view of collar 148a, and FIG. 4D illustrates a side cross-sectional view of collar 148a. These figures illustrate that collar 148a can include three equally spaced indexes 160a. Indexes of the present disclosure can extend radially outward.

FIG. 5A illustrates a top-perspective view of collar 148b. Similar to collar 148a, collar 148b can include an upper surface 150b, apertures 152b and 154b, and body 164b. Upper surface 150b can be substantially circular. In another embodiment, upper surface 150b can take a different geometric shape, such as a square or triangle. Upper surface 150b can define one or more apertures 152b and 154b. Apertures 152b can allow for the passage of warm air that may build up inside a shade to which the collar 148b connects. Aperture 154b can selectively couple to supports of the present disclosure (see support 104a in FIG. 1A) and allow for the passage of wires or cables from outside of a shade into a shade. Collar 148b can couple with the shades and diffusers of the present disclosure.

FIG. 5B illustrates a bottom perspective view of collar 148b. Similar to collar 148a, collar 148b can include wall 158b, indexes 160b, and bottom surface 156b. Collar 148b can also include structure 166 or a central support structure. A manufacturer can position structure 166 within the circumference of wall(s) 158b. Structure 166 can comprise one or more corners 168. In at least one embodiment, one or more of the corners can be formed together such that no space is open between them (see FIG. 8B-2). Each corner 168 can have a ridge 170. Ridge 170 can secure componentry inside collar 148b or act as indexes or slots that interface with componentry. Componentry can include lighting elements, lighting support structures, wiring, fasteners, portions of shade, tinted material layers, etc. Structure 166 can also include one or more panels 172a. Together, panels 172a can define a center opening 174 positioned along the center axis of the collar. Center opening 174 can have one or more apertures defined by panels 172a configured to receive fasteners. Center opening 174 can receive a lighting support structure (e.g., extruded aluminum member) that supports a light element positioned within a modular light fixture. The member can be secured to support using fasteners that pass through the apertures defined by the structure 166. (see FIGS. 5C and 5D, apertures 186a and 186b).

FIG. 5C illustrates another bottom perspective view of the collar 148b. FIG. 5C shows passage 180. Passage 180 can be a channel or pathway that connects aperture 154b with the inside of a shade of the present disclosure through structure 166. An assembler can use the angular shape of passage 180 to secure or run needed wiring or cabling to power or control a lighting element. Structure 166 may include a coupling mechanism 182 (such as a lip or threaded portion) disposed on a portion of its outer surface 184. Coupling mechanism 182 allows an assembler to engage structure 166 with a diffuser of the present disclosure (e.g., another thread, or lip for lip-to-lip engagement, see FIG. 8B-1). A portion of, or the entirety of, structure 166 can be received within a diffuser of the present disclosure such that outer surface 184 abuts an inner surface of the diffuser.

FIG. 5C also illustrates aperture 186a, defined by panel 172a. The manufacturer can size and position aperture 186a to allow for a fastener to pass through and engage a lighting support structure (e.g., an extruded member), thereby locking the lighting support structure in place. Also shown is panel 172a, which has an apex 188 that increases its thickness. As shown in FIG. 5D, panel 172b can have an aperture 186b that aligns with aperture 186a.

FIG. 5D illustrates a side view of collar 148b. As shown, the added thickness provided by apex 188 allows a manufacturer to provide a countersink 190 such that a fastener head or other member or element can sit flush within countersink 190 when passed through apertures 186a (seen in FIG. 5C) and aperture 186b. Any such fastener, member, or element would partially pass through the space defined by center opening 174.

FIG. 5E illustrates a side cross-sectional view of the collar 148b. Diffuser 134b can have a coupling element 192 (e.g., thread or lip) that corresponds to coupling mechanism 182, which allows an assembler to secure the diffuser 134b to collar 148b. In embodiments where diffuser 134b includes a lip rather than a thread, the diffuser 134b may freely rotate relative to the collar even when it is secured thereto. As discussed previously, a portion of the structure 166 can be received within space 194, defined by the internal volume of the diffuser 134b.

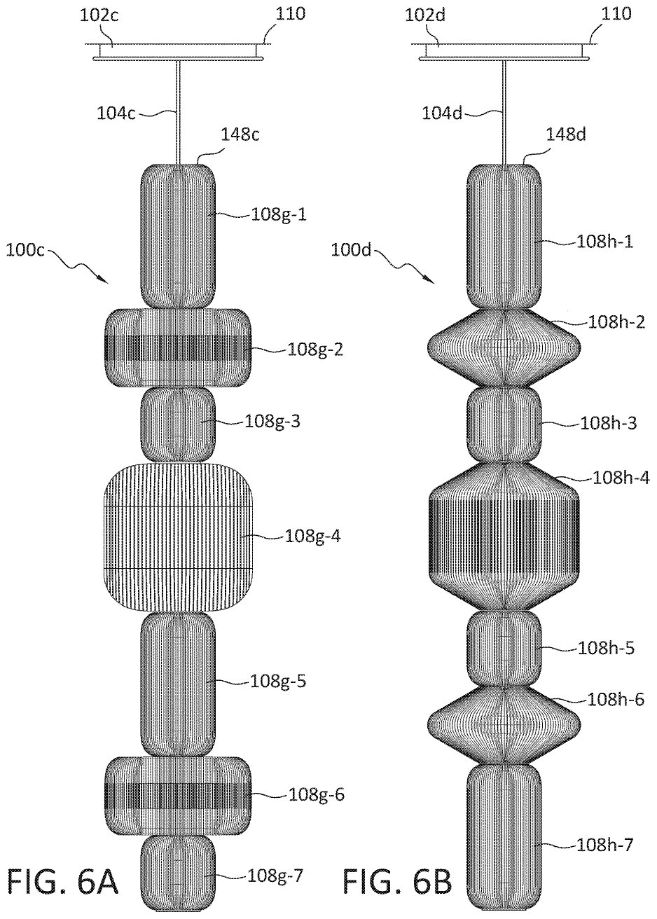

FIG. 6A illustrates a totem light fixture or light fixture 100c. Light fixture 100c can include base 102c, support 104c, collar 148c, and shades 108g-1, 108g-2, 108g-3, 108g-4, 108g-5, 108g-6, and 108g-7. Each shade of the light fixture 100c has a similar geometric profile, but its dimensions are scaled differently. For example, shade 108g-5 is long and skinny, while shade 108g-2 is short and wide. All shades in the light fixture 100c, however, are substantially cylindrical.

Light fixture 100c can be referred to as a totem light fixture because the plurality of shades are vertically stacked along a common central axis to form a continuous, column-like structure. The stacked configuration can create a sculptural, tower-like appearance in which individual shade segments are visually distinct yet mechanically and optically integrated. Each adjacent pair of shades can interface via corresponding neck and coupling elements, as described above, thereby securing the shades together through rotational engagement and frictional locking. In certain embodiments, magnets, set screws, diffuser fins, or other retention mechanisms can further resist unintended rotation between stacked shades, thereby maintaining alignment along the central axis.

In at least one embodiment, one or more diffusers (or a diffuser bar) extends through multiple shades and, in some configurations, substantially the entire axial length of light fixture 100c. For example, a diffuser bar can extend from collar 148c through shades 108g-1 through 108g-7, thereby providing a consistent internal light source throughout the stacked structure. Thus, multiple diffuser segments can be coupled end-to-end within the stacked shades, as previously described, to achieve the desired overall height. By allowing the diffuser or diffuser segments to span multiple shade interfaces, the totem light fixture 100c can produce a cohesive and consistent lighting effect with reduced dark zones at shade junctions while preserving the modularity of the external shade components.

FIG. 6B illustrates an embodiment of a totem light fixture or light fixture 100d. Light fixture 100d can include base 102d, support 104d, collar 148d, and shades 108h-1, 108h-2, 108h-3, 108h-4, 108h-5, 108h-6, and 108h-7. Shades 108h-1, 108h-3, 108h-5, and 108h-7 are substantially cylindrical, while shades 108h-2, 108h-4, and 108h-6 are more angular and have a saucer-like geometric profile. Shades of the present disclosure can have a variety of geometric profiles, and totem light fixtures can combine any number of geometric profiles to accomplish a specific functional or aesthetic design.

FIG. 7A illustrates a horizontal light fixture 100g of the present disclosure. Light fixture 100g can include a plurality of shades 108k coupled end-to-end along a common longitudinal axis. Similar to the vertically oriented embodiments described above, each shade 108k can include corresponding neck and coupling elements that permit adjacent shades 108k to be rotationally engaged and frictionally locked together. In the embodiment shown, the stacked shades form an elongated structure that extends laterally, thereby defining light fixture 100g as a horizontal light fixture rather than a vertically stacked configuration.

In at least one embodiment, horizontal light fixture 100g includes an internal diffuser bar that extends through multiple shades 108k and, in some configurations, substantially the entire length of light fixture 100g. The diffuser bar can support one or more lighting elements and can provide consistent light transmission across shade interfaces. The diffuser bar can be a single continuous member or can include multiple diffuser segments coupled together within the internal cavities of the shades 108k.

FIG. 7A further identifies a first end region (shown in greater detail in FIG. 7B), a middle support region (shown in greater detail in FIG. 7C), and a second end region (shown in greater detail in FIG. 7D). The end regions can include collars configured to couple with the shades 108k and to support and align the internal diffuser bar, while the middle support region can provide intermediate structural reinforcement along the horizontal span. Collectively, these components assist in maintaining axial alignment of the shades 108k and help keep the diffuser bar centered within the horizontal light fixture 100g. The horizontal configuration of light fixture 100g can allow for installation across ceilings, between opposing walls, along architectural beams, or beneath overhangs while maintaining the modular and scalable characteristics described herein.

FIG. 7B illustrates a cross-sectional view of a first end of horizontal light fixture 100g. As shown, shade 108k is coupled to collar 148e, which is configured to support internal components and interface with a mounting or power structure. Collar 148e can engage shade 108k using the rotational and frictional coupling features described above. The Figure also shows that diffuser 134c is positioned within shade 108k and includes a coupling element 192 and a coupling element 200. Coupling element 200 can take the form of internal threading that extends along a substantial portion of the axial length of diffuser 134c. In some embodiments, the internal threading extends for more than one-half, and in other embodiments, more than two-thirds, of the diffuser length. This extended threaded region can allow an installer to cut diffuser 134c to a selected length while still retaining sufficient internal threads to engage another collar, cap, or adjacent diffuser segment. As such, coupling element 200 allows for modular length adjustment while preserving secure mechanical engagement.

FIG. 7B further illustrates one or more lips (coupling element 192 and coupling mechanism 182) formed between collar 148e and diffuser 134c. Coupling mechanism 182 can engage coupling element 192 to prevent axial separation of the diffuser from the collar, while permitting relative rotational movement between diffuser 134c and collar 148e. This arrangement allows diffuser 134c to rotate independently of collar 148e. In embodiments where diffuser 134c includes external fins or alignment features configured to engage corresponding slots or features of shade 108k, rotation of diffuser 134c relative to the shade may not be possible. Consequently, collar 148e can be rotated to lock or unlock shade 108k without requiring simultaneous rotation of diffuser 134c, thereby simplifying assembly and maintaining alignment of optical features.

FIG. 7B also shows a lighting support structure 202 that extends along the central axis of diffuser 134c (and the light fixture generally). Lighting support structure 202 can engage collar 148e at one end and can extend longitudinally through diffuser 134c to support one or more light sources 204, shown as LEDs. Lighting support structure 202 can be a rigid or semi-rigid member, such as a metal extrusion, that provides both structural reinforcement and a thermal pathway for heat dissipation from light sources 204.

FIG. 7B also illustrates supports 104b-1 and 104b-2. Support 104b-1 can take the form of an electrical conduit that routes power to the light source 204. Support 104b-2 can take the form of a cable coupled to collar 148e through a pivotable attachment point. The pivotable connection can permit angular adjustment, including approximately 90-degree orientation relative to the longitudinal axis of horizontal light fixture 100g, thereby enabling flexible mounting configurations and routing of electrical connections.

FIG. 7C illustrates a cross-sectional view of an intermediate support region of horizontal light fixture 100g. As shown, an intermediate member 206 can engage a support 104c to provide structural reinforcement at a location between opposing ends of light fixture 100g. Support 104c can take the form of a mounting bracket, rod, cable, or other structural element configured to secure horizontal light fixture 100g to a ceiling, wall, beam, or other architectural structure. Intermediate member 206 can thus provide support at a central or otherwise selected position along the longitudinal length of light fixture 100g to reduce deflection and maintain alignment.

Intermediate member 206 can be configured to mechanically interface with adjacent shades 108k-1 and 108k-2. For example, intermediate member 206 can receive connection element 112 of shade 108k-1 in a manner similar to the engagement between stacked shades described above. Intermediate member 206 can further include its own connection element 208, which can be analogous to connection element 112, and can engage a corresponding neck portion of shade 108k-2. In this manner, intermediate member 206 can function as both a structural support interface and a coupling interface between adjacent shades.

As further shown, diffuser 134d and lighting support structure 202 extend through the intermediate region. In at least one embodiment, intermediate member 206 can include one or more slots (such as slots 120), channels, or reliefs configured to permit passage of external fins or alignment features formed on diffuser 134d. These slots can allow diffuser 134d to remain rotationally indexed relative to shades 108k-1 and 108k-2 while permitting intermediate member 206 to be installed without interference. Furthermore, a central aperture can allow for the passage of diffuser 134d through intermediate member 206. Accordingly, intermediate member 206 can provide structural support without disrupting optical alignment or rotational indexing of diffuser 134d within horizontal light fixture 100g.

FIG. 7D illustrates a cross-sectional view of a second end of horizontal light fixture 100g. As shown, collar 148f engages with a connection element of shade 108k-3 in a manner analogous to the previously described collar-to-shade interfaces. Collar 148f can be rotationally coupled to shade 108k-3 and can provide axial retention once locked into position. Collar 148f can further engage diffuser 134d at surface 216. In at least one embodiment, surface 216 permits rotational movement between collar 148f and diffuser 134d while maintaining radial support. This arrangement can allow diffuser 134d to remain rotationally indexed relative to lighting support structure 202 and associated optical features, while collar 148f is rotated to lock or unlock shade 108k-3.

FIG. 7D further illustrates a cap assembly that can include a first member 210 and a second member 214. The first member 210 can include internal threads configured to engage the corresponding threads of the diffuser 134d. In this manner, member 210 can threadably couple to diffuser 134d, thereby providing axial retention. Member 210 can further include a lip 212 that captures or interfaces with second member 214. Lip 212 can permit rotational freedom between members 210 and 214 while preventing axial separation. Second member 214 can engage lighting support structure 202 to maintain lighting support structure 202 in a centered position along the central axis of diffuser 134d. Because member 214 engages lighting support structure 202 and member 210 threadably engages diffuser 134d, and because lip 212 permits relative rotation between members 210 and 214, diffuser 134d can rotate relative to lighting support structure 202. This rotational independence can facilitate the locking and unlocking of collars, such as collar 148e shown in FIG. 7B, without requiring a corresponding rotation of the lighting support structure 202.

FIG. 7D also illustrates support 104d, which can be similar in structure and function to support 104b-2 described with respect to FIG. 7B. Support 104d can take the form of a cable coupled to collar 148f through a pivotable attachment point, thereby permitting angular adjustment and facilitating routing of power or structural suspension of horizontal light fixture 100g.

FIG. 8A illustrates a mountable light fixture 100h of the present disclosure. Light fixture 100h can include one or more shades 108l coupled along a central axis in a stacked configuration. Similar to previously described embodiments, each shade 108l can include corresponding neck and coupling elements that permit rotational engagement and frictional locking between adjacent shades. Light fixture 100h can further include one or more diffusers, such as diffuser 134d, extending along at least a portion of the axial length of the stacked shades 108l.

A lighting support structure 202 can extend centrally through diffuser 134d and along the longitudinal axis of light fixture 100h. As shown, a cap 220 can be positioned at the upper end of light fixture 100h. Cap 220 can include a pin or projection that extends into lighting support structure 202 to maintain lighting support structure 202 in a centered position within diffuser 134d and shades 108l. The engagement between cap 220 and lighting support structure 202 can provide axial stability and assist in maintaining consistent optical alignment.

Light fixture 100h can be coupled to a base 222 positioned at a lower end of the fixture. Base 222 can function as a collar that engages a lower shade 108l while also providing structural support for mounting or supporting a light fixture in a standalone configuration (e.g., a lamp). Base 222 can be configured for attachment to a floor, wall, ceiling, pedestal, or other architectural surface. In this manner, light fixture 100h can be implemented as a floor-mounted totem, a wall-mounted vertical feature, or a ceiling-mounted installation. FIG. 8B-1 illustrates a more detailed view of base 222 and the connection interfaces provided thereat.

The inclusion of base 222 can provide several advantages. For example, base 222 can distribute loads from the stacked shades 108l and internal components into the mounting surface, thereby improving stability. Base 222 can also house electrical connections, drivers, or routing pathways for wiring, thereby simplifying installation and concealing functional components. By integrating structural and electrical interfaces into base 222, light fixture 100h can achieve a clean exterior appearance while maintaining modularity of the shade and diffuser components.

Features described with respect to other shades 108, diffusers, collars, and support structures herein can be incorporated into shades 108l and diffuser 134d of light fixture 100h. For example, internal and external baffles, threaded diffuser coupling elements, rotational indexing features, magnetic retention mechanisms, and segmented diffuser assemblies can be applied to the mountable configuration. Conversely, structural and mounting features described with respect to light fixture 100h may be implemented in other vertical or horizontal embodiments described herein. Accordingly, the mountable light fixture 100h demonstrates the modular system's adaptability across various installation environments while preserving the mechanical, optical, and aesthetic benefits previously discussed.

FIG. 8B-1 illustrates a cross-sectional view of base 222 and associated connection features of mountable light fixture 100h. As shown, base 222 includes a lower surface 224 configured for mounting to an external structure. Lower surface 224 can be substantially planar and can include one or more apertures, fastener locations, threaded inserts, or other attachment features that permit securement to a floor, wall, ceiling, pedestal, or similar support surface. In this manner, base 222 can transfer loads from the stacked shades and internal components into the mounting structure.

FIG. 8B-1 further illustrates the rotationally free interface between diffuser 134d and base 222, similar to the lip configuration previously described. For example, one or more coupling elements 192 can engage one or more coupling mechanisms 182 to prevent axial separation while permitting relative rotational movement between diffuser 134d and base 222. Lighting support structure 202 can extend centrally through this interface and remain aligned along the central axis. This rotational freedom can permit base 222 to be securely fastened to a mounting surface without requiring rotation of diffuser 134d or associated optical components. In embodiments where diffuser 134d includes one or more locking fins or indexing features that engage corresponding slots or features of shade 108l, diffuser 134d can remain rotationally fixed relative to shade 108l while base 222 is independently secured. As a result, installation can be simplified, and proper optical alignment and aesthetic orientation of the stacked shades can be maintained even after base 222 is mounted.

FIG. 8B-2 illustrates a perspective and partially exploded view of base 222 of mountable light fixture 100h. As shown, lighting support structure 202 extends upward from base 222 along the central axis. Base 222 can define a central opening aligned with lighting support structure 202 and can incorporate structural features analogous to collar 148b previously described.

In particular, base 222 can include an internal support structure similar to structure 166 having panels that define a center opening 174 positioned along the central axis. Center opening 174 can be configured to receive lighting support structure 202 and can include one or more apertures configured to receive fasteners that secure lighting support structure 202 in place. In this manner, lighting support structure 202 can be rigidly supported relative to base 222 while remaining aligned with the stacked shades and diffuser.

Base 222 can further include indexes 160c that are analogous to indexes 160b. Indexes 160c can protrude radially and can be configured to engage corresponding receiving elements of a neck of a shade 108l. Through rotational engagement, index 160c can permit a shade 108l to be twisted and locked onto base 222 in a manner similar to the collar-to-shade interfaces described elsewhere herein. Accordingly, base 222 can function as a structural collar that both mounts to an external surface and mechanically interfaces with a lower shade.

Because shades 108l and diffusers 134d are removably coupled through rotational and threaded engagements, they can be selectively removed from base 222 for servicing, replacement, or reconfiguration. For example, a shade 108l can be counter-rotated relative to indexes 160c to disengage from base 222. Similarly, diffuser 134d can be unthreaded or unsecured from a coupling element or cap assembly and withdrawn axially once the associated shade is removed. Lighting support structure 202 can remain secured within center opening 174, thereby allowing optical components to be serviced independently of the mounting base.

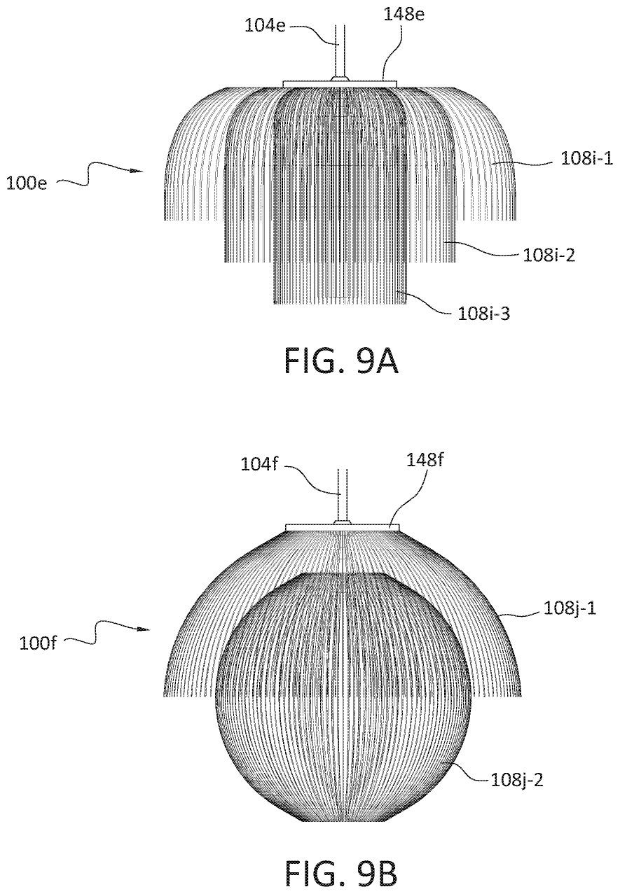

FIG. 9A illustrates a nested light fixture 100e of the present disclosure. Shade 108i-1 can receive a portion of shade 108l-2, and shade 108i-2 can receive a portion of shade 108l-3, resulting in a nested design. Each shade can have an open bottom. In one embodiment, shades 108i-1 can have a coupling element disposed near their necks that allows an assembler to selectively secure another shade within a portion of their internal volume. Similarly, shades 108i-2, and 108l-3 can have coupling elements disposed near their necks. In yet another embodiment, a collar of the present disclosure can have a plurality of coupling elements to allow a plurality of shades to be coupled to the collar.

FIG. 9B illustrates the nested light fixture 100f of the present disclosure. Shade 108j-1 has an open lower portion capable of receiving a portion of shade 108j-2. Shade 108j-2, however, has a close lower portion. Furthermore, shade 108j-2 is an example of a spherical shade of the present disclosure.

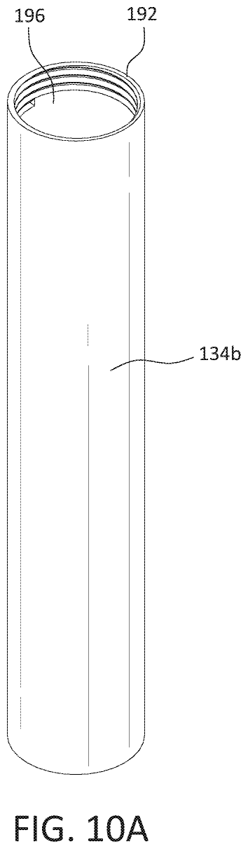

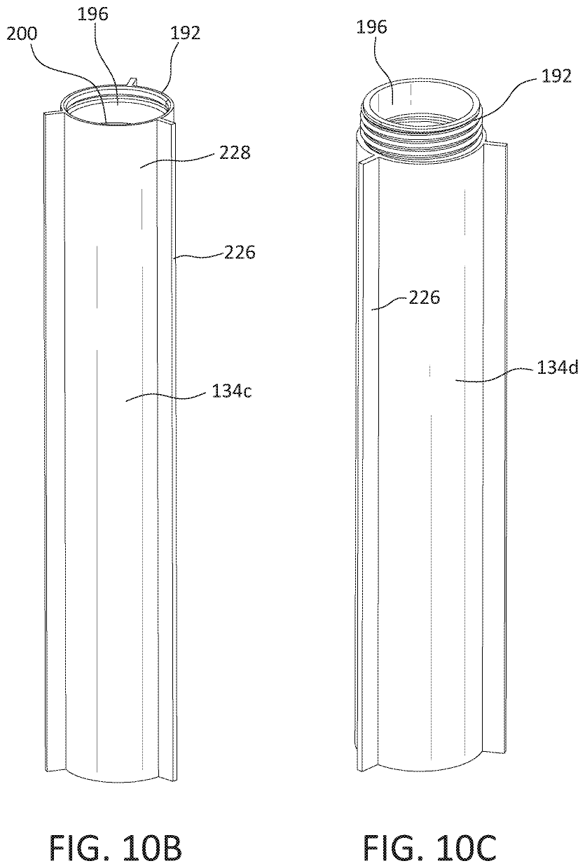

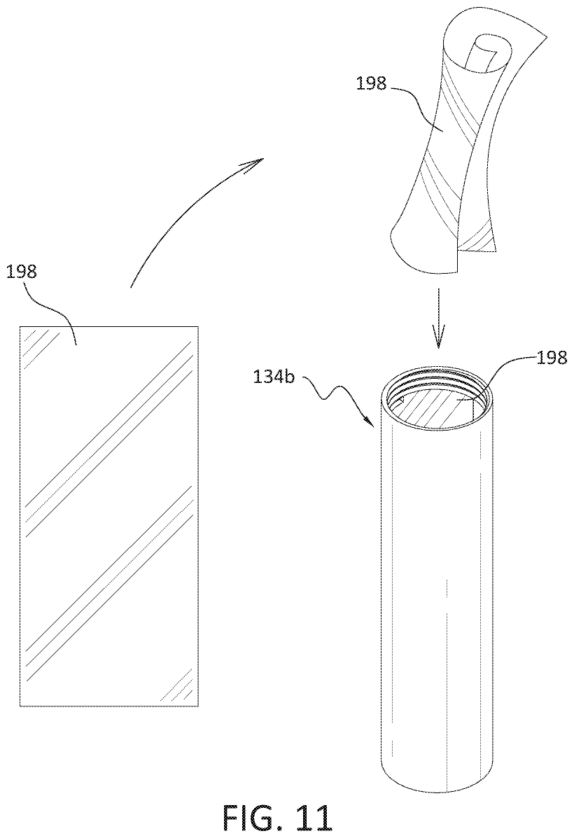

FIG. 10A illustrates diffuser 134b. Diffuser 134b can be substantially cylindrical. Diffuser 134b can have a coupling element 192 disposed on an interior surface 196. Diffuser 134b can allow for the transmission of light through its interior surface 196. A manufacturer can construct diffuser 134b to any length. The manufacturer can determine the length of diffuser 134b for any aesthetic or functional purpose. For example, the manufacturer can form a shorter diffuser for a shorter shade. The manufacturer may also construct a diffuser 134b from a colored material to produce a colored or tinted light for an end user. In another embodiment, a colored or tinted film can be inserted into diffuser 134b to change the perceived color output of a lighting element that resides inside of diffuser 134b. The film can be pressed against the inner surface 196 by rolling up the film and letting it unfurl inside the diffuser, allowing a user to swap the colors without having to change the diffuser each time. (See FIG. 11).

FIGS. 10B and 10C illustrate additional embodiments of diffusers 134c and 134d that may be used to form a diffuser bar through end-to-end coupling. Similar to diffuser 134b, diffusers 134c and 134d can be substantially cylindrical and can permit transmission of light through an interior surface 196.

As shown in FIG. 10B, diffuser 134c can include an outer surface 228 having one or more fins 226 protruding radially therefrom. In various embodiments, diffuser 134c can include 1, 2, 3, 4, 5, 6, 7, 8, or more fins 226 spaced circumferentially around outer surface 228. Fins 226 can extend longitudinally along at least a portion of the diffuser length. Fins 226 can be configured to engage corresponding slots or recesses formed in a shade, thereby rotationally indexing diffuser 134c relative to the shade. By fitting into such slots, fins 226 can prevent rotation of the shade relative to diffuser 134c while permitting other components, such as a collar, to rotate independently during locking or unlocking. This arrangement can assist in maintaining optical alignment and aesthetic orientation of the shade assembly.

Diffuser 134c can further include a coupling element 192 disposed near one end. In the embodiment of FIG. 10B, coupling element 192 can take the form of a lip that permits axial retention while allowing rotational movement relative to a mating component. Thus, in some embodiments, no threads are used to couple the diffuser to the collar or additional component. Diffuser 134c can also include internal threading (coupling element 200) disposed on the interior surface 196. Coupling element 200 can extend along the entire axial length of diffuser 134c or along a substantial portion thereof. In some embodiments, coupling element 200 extends for more than one half, and in other embodiments more than two thirds, of the diffuser length. By providing extended coupling element 200, diffuser 134c can be cut to a desired length at an installation site while still retaining sufficient threaded engagement to couple with another diffuser, collar, or cap. Accordingly, diffuser 134c can be manufactured in longer stock lengths and customized on site to fit a selected shade configuration.

FIG. 10C illustrates diffuser 134d, which can include fins 226 similar to those described above. In the embodiment of FIG. 10C, coupling element 192 can take the form of an externally facing thread configured to engage coupling element 200 of another diffuser, such as diffuser 134c. Through threaded engagement between external threads (coupling element 192) and coupling element 200, multiple diffuser segments can be coupled end to end to form a continuous diffuser bar. This modular arrangement can allow installers to assemble diffuser bars of varying lengths by selectively coupling and trimming diffuser segments while maintaining secure threaded engagement and alignment.

FIG. 11 illustrates a sequence of inserting film 198 into diffuser 134b. An assembler can first roll or fold film 198. The assembler can then insert film 198 into an opening of diffuser 134b. Once inserted, film 198 is free to unfurl inside diffuser 134b and frictionally retain and conform itself inside the inner surface of diffuser 134b. Film 198 can be a transparent or semi-transparent material. Film 198 can be colored or tinted. Thus, an assembler can use film 198 to allow a modular light fixture with a white light to produce light of varying colors without replacing the lighting element. In another embodiment, a manufacturer can construct diffuser 134b with a colored material to accomplish a similar goal of allowing a white light lighting element to provide a colored light to a user.

The present disclosure teaches innovative modular light fixtures designed for both public and private spaces, emphasizing ease of assembly and customization. The modular design allows users to easily configure and reconfigure the fixtures to suit their aesthetic and functional needs, offering a cost-effective solution for personalized lighting.

Manufacturers and end users can construct these modular light fixtures using various materials through an additive manufacturing or 3D printing process. These processes provide versatility in material choice, allowing for a wide range of design possibilities and ensuring that the fixtures meet diverse aesthetic and functional requirements.

The ability to easily disassemble and reassemble these fixtures for cleaning or reconfiguration is a significant advantage. It enhances the fixtures' longevity and allows users to adapt their lighting to changing needs and preferences. The use of magnets for secure attachment adds a modern touch, ensuring that the components stay in place while still being easy to adjust. Overall, the modular light fixtures of the present disclosure provide a forward-thinking approach to lighting design, combining practicality with aesthetic flexibility.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A modular light fixture comprising:
a collar comprising one or more indexes that protrude outward and radially;
a shade comprising a neck defining an opening that receives the collar;
a diffuser disposed within an internal volume of the shade; and
a retention mechanism that resists rotation of the collar relative to the shade,
wherein:
the neck comprises one or more receiving elements that engage the one or more indexes upon relative rotational movement between the collar and the shade, and
the collar comprises a coupling mechanism to engage the diffuser and to retain the diffuser within the internal volume of the shade.

2. The modular light fixture of claim 1, further comprising a second shade configured to couple to the shade in a stacked arrangement.

3. The modular light fixture of claim 2, wherein:
the shade further comprises a coupling element disposed on an end that is opposite the neck; and
the coupling element comprises one or more radially outwardly protruding projections and corresponding receiving elements configured to rotationally engage complementary receiving elements and projections of the second shade.

4. The modular light fixture of claim 1, wherein the diffuser is axially retained by a threaded engagement with the collar that permits rotational adjustment of the diffuser relative to the shade.

5. The modular light fixture of claim 1, wherein the coupling mechanism of the collar comprises a lip that engages with a lip of the diffuser.

6. The modular light fixture of claim 1, further comprising a light source support extending along a central axis through the diffuser.

7. The modular light fixture of claim 1, wherein the retention mechanism comprises one or more magnets within the neck and within the collar.

8. The modular light fixture of claim 1, wherein at least one of the one or more indexes or the one or more receiving elements comprises a tapered or cam surface configured to increase frictional engagement during rotational movement.

9. A shade for use in modular light fixtures comprising:
one or more external baffles that extend from a first end of the shade to a second end of the shade, wherein each of the one or more external baffles comprises an interior edge and an outer edge;
an inner shell that engages the interior edge of the one or more external baffles; and
a neck disposed at the first end of the shade, wherein the neck defines an opening into an internal volume of the shade;
wherein:
the neck comprises one or more receiving elements that recess into the inner shell; and
the outer edge of the one or more external baffles forms an outermost perimeter of the shade.

10. The shade of claim 9, further comprising a coupling element disposed at the second end of the shade, the coupling element defining a second opening into the internal volume of the shade.

11. The shade of claim 10, wherein the coupling element comprises one or more walls and one or more indexes that protrude radially outward from the one or more walls.

12. The shade of claim 9, further comprising one or more internal baffles disposed within the internal volume of the shade.

13. The shade of claim 9, wherein each of the one or more internal baffles is circumferentially aligned with a corresponding one of the one or more external baffles that extend from the first end to the second end of the shade.

14. The shade of claim 9, wherein the neck comprises one or more slots extending axially through a thickness of the neck.

15. A collar for use in a modular light fixture comprising:
a body having an upper surface and a lower surface;
one or more walls that extend from the lower surface of the body and define a central opening;
one or more apertures that extend through the body between the upper surface and the lower surface;
one or more indexes that extend radially from the one or more walls; and
a central support structure disposed within the central opening,
wherein the one or more indexes are configured to engage corresponding receiving elements of a shade upon relative rotational movement between the collar and the shade to resist axial separation.

16. The collar of claim 15, further comprising a central support structure having a threaded portion wherein the structure extends from the lower surface of the body and within a space defined by the one or more walls.

17. The collar of claim 15, further comprising a central support structure comprising a circumferential lip, wherein the central support structure extends from the lower surface of the body and within a space defined by one or more walls.

18. The collar of claim 15, further comprising one or more fins.

19. A method of assembling the modular light fixture of claim 1, the method comprising:
securing a lighting support structure to the collar;
engaging a diffuser with a central support structure of the collar;
inserting the diffuser and the collar into an opening defined by the neck; and
twisting the collar relative to the shade to engage an index disposed on the collar with a receiving element disposed on the neck of the shade.

20. The method of claim 19, wherein the collar rotates separately from the diffuser.
